(19) United States
(12) Patent Application Publication
(10) Pub. No.: US 2003/0202118 A1
(43) Pub. Date: Oct. 30, 2003

(54) Portable apparatus

(75) Inventors: Ken Hirunuma, Tokyo (JP); Gouji Funatsu, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation

(21) Appl. No.: 10/419,126

(22) Filed: Apr. 21, 2003

(30) Foreign Application Priority Data
Apr. 24, 2002 (JP) P2002-122378

(51) Int. Cl. H04N 5/225

(52) U.S. Cl. 348/373

(57) ABSTRACT

A portable apparatus comprises an inner frame, a casing attached to the inner frame, and a display panel. The display panel is directly connected to the inner frame and is movable between a folded position and a display position. A panel passing opening is formed in the casing. The display panel is set to a predetermined position between the folded position and the display position, so that the display panel can pass through the panel passing opening, enabling the casing to be attached to and detached from the inner frame.

### BACKGROUND OF THE INVENTION

1. Field of the Invention

The present invention relates to a portable apparatus which has an inner frame, a casing attached to the inner frame, and a display panel.

2. Description of the Related Art

As examples of such portable apparatuses, there are digital video cameras or electronic still cameras, which use a solid-state imaging device, and observation optical devices, with a photographing function, which use an electronic still camera. These portable apparatuses are provided with a display panel so as to display a subject image as a moving image, a photographed image as a still image, or character images that might indicate photographing condition data for instance. In most cases, the display panel is disposed on a casing of the portable apparatus, and is movable between a folded position and a display position.

In a final process of a manufacturing line of the portable apparatus, an adjustment of each part, and a product check, are carried out. The adjustment includes a white-balance adjustment of a CCD, a color adjustment, a sensitivity adjustment, a luminance adjustment of an LCD, a contrast adjustment, and so on. The product check includes a check to determine whether the display panel operates properly or not. During the check, a casing is removed so that an electronic control circuit board and so on of the portable apparatus can be accessed, and the display panel is also removed from the casing and put in a proper place. At this time, the display panel should be placed in such a manner that the display surface faces the operator.

The electronic control circuit board and the display panel are connected through a flat flexible wiring cord, and therefore it is difficult for the display panel to be stably placed while the display surface faces the operator. For example, the display panel may move or fall down if the operator touches the flexible wiring cord during the check. In such a case, it is necessary to replace the display panel at the original position, which lowers the checking efficiency for the product. On the other hand, although it is possible to provide a panel setting table for stably supporting the display panel during the check, the usage of the panel setting table increases the manufacturing cost of the portable apparatus.

### SUMMARY OF THE INVENTION

Therefore, an object of the present invention is to provide a portable apparatus, which is constructed in such a manner that the checking of the portable apparatus can be carried out without incurring any additional cost.

According to the present invention, there is provided a portable apparatus comprising an inner frame, a casing, and an image casing. The casing is attached to the inner frame. The display panel is directly connected to the inner frame and is movable between a folded position and a display position. The casing is provided with a panel passing opening, through which the display panel, set to a predetermined position between the folded position and the display position, passes so that the casing is attached to the inner frame.

The casing may be provided with a cover that covers the panel passing opening in association with the display panel so that the panel passing opening is not exposed after the casing is attached to the inner frame. Preferably, the cover is integrally formed on the casing. The display panel and the cover form a space therebetween, in which a part of a flexible wiring cord connected to the display panel is housed.

The portable apparatus may further comprise an electronic photographing device having a photographing optical system and an imaging device operating in combination with the photographing optical system, the display panel indicating an image obtained by the electronic photographing device. The portable apparatus may further comprise an observation optical system functioning as a viewfinder optical system for the electronic photographing device. The observation optical system may comprise a pair of telescopic systems. The portable apparatus may further comprise an optical system mount plate that is supported by the inner frame so as to support the pair of telescopic optical systems. In this case, the optical system mount plate has first and second plate that are slidable relative to each other, and one of the pair of telescopic optical systems is mounted on the first plate, while the other of the pair of telescopic optical systems is mounted on the second plate. A relative position between the first and second plates is changed so that a distance between the optical axes of the pair of telescopic optical systems is adjusted.

Preferably, the first and second plates are linearly moved relative to each other in such a manner that the optical axes of the pair of telescopic optical systems are moved in a predetermined plane, so that the distance between the optical axes of the pair of telescopic optical systems is adjusted. The casing may comprise a main casing section that is fixed on the first plate, and a movable casing section that is fixed on the second plate and that is movable between a retracted position and an extended position relative to the main casing section. The panel passing opening is formed in the main casing section. Optionally, the main casing section is divided into a top part and a bottom part, the display panel being mounted on the top part, and the panel passing opening being formed in the top part.

### BRIEF DESCRIPTION OF THE DRAWINGS

The objects and advantages of the present invention will be better understood from the following description, with reference to the accompanying drawings in which:

FIG. 1 is a horizontal sectional view showing an embodiment of a portable apparatus according to the present invention, in a state in which a movable casing section is set at a retracted position;

FIG. 2 is a sectional view along line II-II of FIG. 1;

FIG. 3 is a horizontal sectional view similar to FIG. 1, the movable casing section being set at a maximum-extended position;

FIG. 4 is a horizontal sectional view similar to FIG. 2, the movable casing section being set at a maximum-extended position;

FIG. 5 is a plan view showing an optical system mount plate provided in a casing of the portable apparatus shown in FIG. 1;

FIG. 6 is a plan view showing right and left mount plates which are disposed on the optical system mount plate shown in FIG. 5;

FIG. 7 is an elevational view observed along line VII-VII of FIG. 6, in which the optical system mount plate is indicated as a sectional view along line VII-VII of FIG. 5;

FIG. 8 is an elevational view observed along line VIII-VIII of FIG. 1;

FIG. 9 is an elevational view similar to FIG. 8, a top portion of a main casing section being removed and an LCD display panel being positioned at an upright position; and

FIG. 10 is a plan view showing the main casing section.

### DESCRIPTION OF THE PREFERRED EMBODIMENTS

The present invention will be described below with reference to the embodiments shown in the drawings.

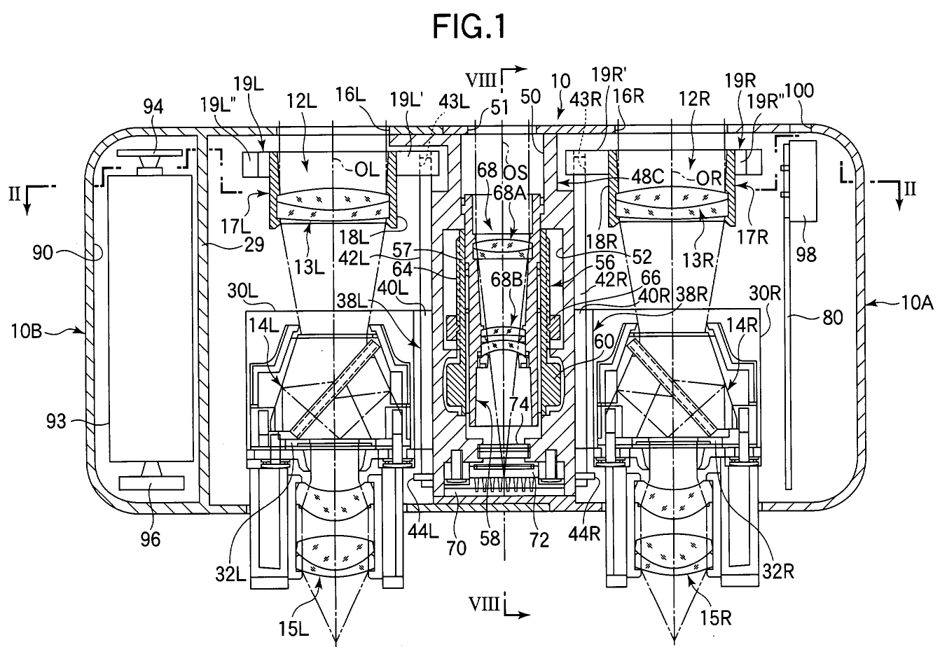

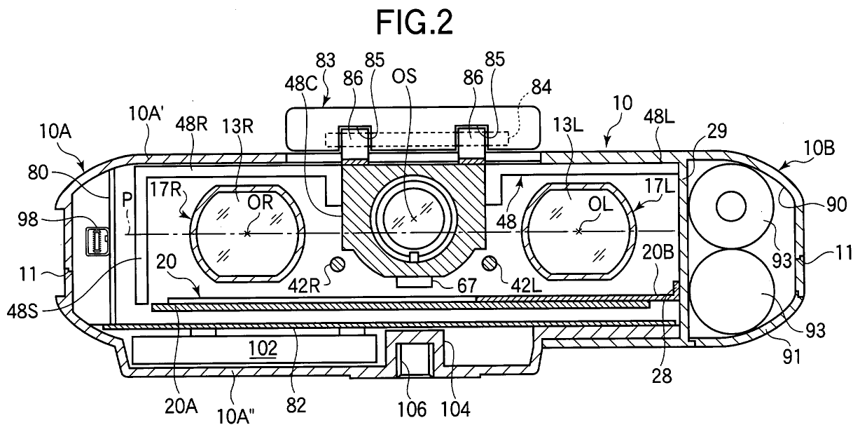

FIG. 1 shows an internal structure of a portable apparatus, to which an embodiment of the present invention is applied, the portable apparatus being a binocular telescope with a photographing function. FIG. 2 is a sectional view along line II-II of FIG. 1, and in FIG. 2, some elements are omitted so as to simplify the drawing. In the embodiment, the binocular telescope has a casing 10, which comprises a main casing section 10A and a movable casing section 10B.

Each of the main casing section 10A and the movable casing section 10B is integrally formed of reinforced plastic material, which contains carbon fibers, for example, as the reinforcing material. The main casing section 10A is divided into two parts, i.e., a top part 10A′ and a bottom part 10A″, which are joined to each other. The joint is indicated by reference 11 in FIG. 2.

A pair of telescopic optical systems 12R and 12L are provided in the casing 10. The telescopic optical systems 12R and 12L have a symmetrical structure, and are used for a right telescopic optical system and a left telescopic optical system. The right telescopic optical system 12R is mounted in the main casing section 10A, and contains an objective lens system 13R, an erecting prism system 14R, and an ocular lens system 15R. An observation window 16R is formed in a front wall of the main casing section 10A, and is aligned with the objective lens system 13R. The left telescopic optical system 12L is mounted in the movable casing section 10B, and contains an objective lens system 13L, an erecting prism system 14L, and an ocular lens system 15L. An observation window 16L is formed in a front wall of the movable casing section 10B, and is aligned with the objective lens system 13L.

Note that for simplicity of explanation, in the following description, front and back are respectively defined as a side of the objective lens system and a side of the ocular lens system, relative to the pair of telescopic optical systems 12R and 12L, and right and left are respectively defined as the right side and the left side when facing the ocular lens systems 15R and 15L.

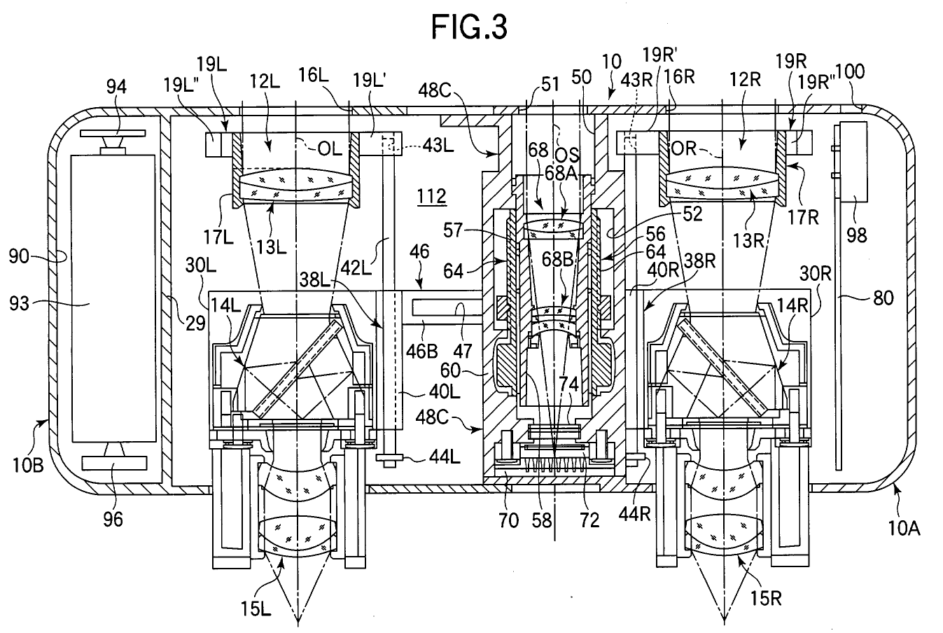

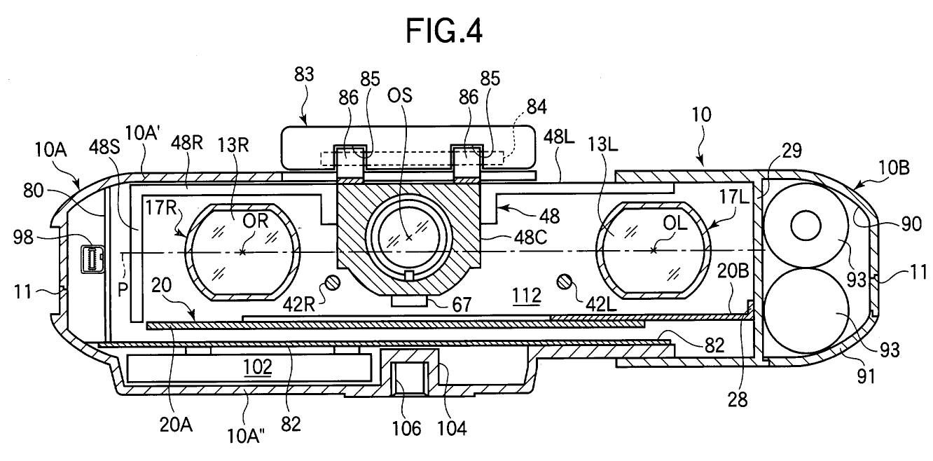

The movable casing section 10B is slidably engaged with the main casing section 10A such that the movable casing section 10B can be moved relative to the main casing section 10A. Namely, the movable casing section 10B is movable between a retracted position shown in FIGS. 1 and 2, and a maximum-extended position in which the movable casing section 10B is pulled out from the retracted position, shown in FIGS. 3 and 4. A suitable friction force acts on the sliding surfaces of both the casing sections 10A and 10B, and thus a certain extension or contraction force must be exerted on the movable casing section 10B before the movable casing section 10B can be extended from or contracted onto the main casing section 10A. Thus, it is possible for the movable casing section 10B to hold or stay still at an optical position between the fully retracted position (FIGS. 1 and 2) and the maximum-extended position (FIGS. 3 and 4), due to the suitable friction force acting on the sliding surface of both the casing sections 10A and 10B.

As understood from the comparison between FIGS. 1 and 2 and FIGS. 3 and 4, when the movable casing section 10B is pulled out from the main casing section 10A, the left telescopic optical system 12L is moved together with the movable casing section 10B, while the right telescopic optical system 12R is held in the main casing section 10A. Thus, by positioning the movable casing section 10B at an arbitrary extended position relative to the main casing section 10A, the distance between the optical axes of the ocular lens systems 15R and 15L, i.e., the interpupillary distance is adjusted. When the movable casing section 10B is set at the retracted position relative to the main casing section 10A, the distance between the telescopic optical systems 12R and 12L becomes the minimum (FIGS. 1 and 2), and when the movable casing section 10B is set at the maximum-extended position relative to the main casing section 10A, the distance between the telescopic optical systems 12R and 12L becomes the maximum (FIGS. 3 and 4).

The objective lens system 13R of the right telescopic optical system 12R is housed in a lens barrel 17R, which is mounted at a fixed position relative to the main casing section 10A, and the erecting prism system 14R and the ocular lens system 15R can be moved back and forth with respect to the objective lens system 13R, so that the right telescopic optical system 12R can be focused. Similarly, the objective lens system 13L of the left telescopic optical system 12L is housed in a lens barrel 17L, which is mounted at a fixed position relative to the movable casing section 10B, and the erecting prism system 14L and the ocular lens system 15L can be moved back and forth with respect to the objective lens system 13L, so that the left telescopic optical system 12L can be focused.

The lens barrel 17R has a cylindrical portion 18R, in which the objective lens system 13R is housed, and an attaching base 19R integrally formed under the cylindrical portion 18R. The attaching base 19R has an inside attaching portion 19R′ extending toward the center of the casing 10 from the cylindrical portion 18R, and an outside attaching portion 19R″ extending toward the outside of the casing 10 from the cylindrical portion 18R. The inside attaching portion 19R′ is a side block portion having a relatively large thickness, and the outside attaching portion 19R″ is a flat portion.

Similarly, the lens barrel 17L has a cylindrical portion 18L, in which the objective lens system 13L is housed, and an attaching base 19L integrally formed under the cylindrical portion 18L. The attaching base 19L has an inside attaching portion 19L′ extending toward the center of the casing 10 from the cylindrical portion 18L, and an outside attaching portion 19L″ extending toward the outside of the casing 10 from the cylindrical portion 18L. The inside attaching portion 19L′ is a side block portion having a relatively large thickness, and the outside attaching portion 19L″ is a flat portion.

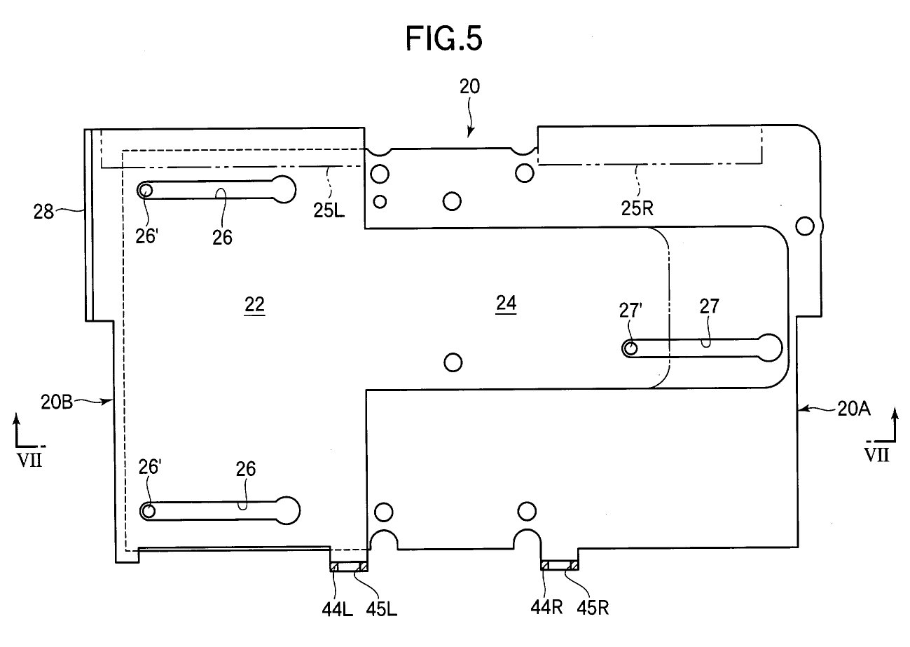

To perform the interpupillary distance adjusting operation and the focusing operation described above, an optical system mount plate 20 shown in FIG. 5 is provided on a bottom side of the casing 10. Note that, in FIGS. 1 and 3, the optical system mount plate 20 is omitted for the simplicity of the drawings.

The optical system mount plate 20 is composed of a rectangular plate 20A, fixed to the main casing section 10A, and a slide plate 20B slidably disposed on the rectangular plate 20A and fixed to the movable casing section 10B. The rectangular plate 20A and the slide plate 20B are made of appropriate metal material, preferably, light metal, such as aluminum or aluminum alloy.

The slide plate 20B has a rectangular portion 22, having approximately the same breadth as the rectangular plate 20A, and an extending portion 24, integrally connected to and extending rightward from the rectangular portion 22. The attaching base 19R of the lens barrel 17R is fixed at a predetermined position on the rectangular plate 20A, and the attaching base 19L of the lens barrel 17L is fixed at a predetermined position on the rectangular portion 22 of the rectangular plate 20B. Note that, in FIG. 5, the fixed position of the attaching base 19R of the lens barrel 17R is indicated as an area enclosed by chain double-dashed line 25R, and the fixed position of the attaching base 19L of the lens barrel 17L is indicated as an area enclosed by chain double-dashed line 25L.

A pair of guide slots 26 are formed in the rectangular portion 22 of the slide plate 20B, and another guide slot 27 is formed in the extending portion 24. A pair of guide pins 26′, slidably engaged with the guide slots 26, and guide pin 27′, slidably engaged with the guide slot 27, are fixed on the rectangular plate 20A. The guide slots 26 and 27 are parallel to each other, and extend in the right and left direction by the same length. The length of each of the guide slots 26 and 27 corresponds to a movable distance of the movable casing section 10B relative to the main casing section 10A, i.e., the distance between the retracted position of the movable casing section 10B (FIGS. 1 and 2) and the maximum-extended position of the movable casing section 10B (FIGS. 3 and 4).

As understood from FIGS. 2 and 4, the optical system mount plate 20 is placed in the casing 10, and separated from the bottom of the casing 10 to form a space therein. The rectangular plate 20A is fixed to the main casing section 10A, and the slide plate 20B is fixed to the movable casing section 10B. Note that, for fixing the slide plate 20B to the movable casing section 10B, a flange 28, extending along the left side edge of the rectangular portion 22, is provided, and fixed on a partition 29 formed in the movable casing section 10B.

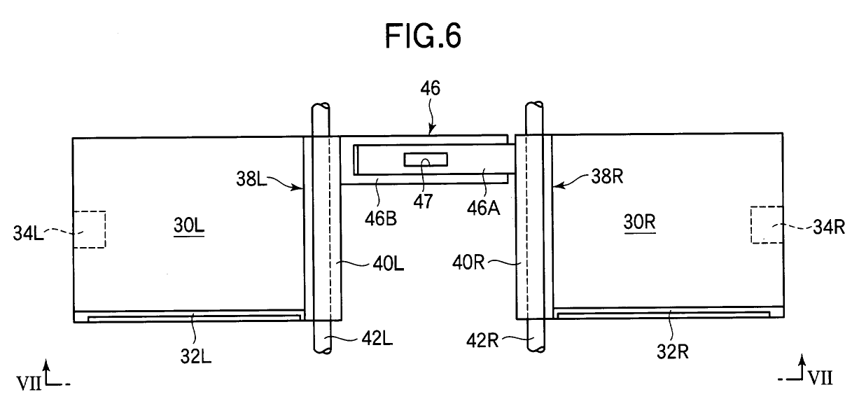

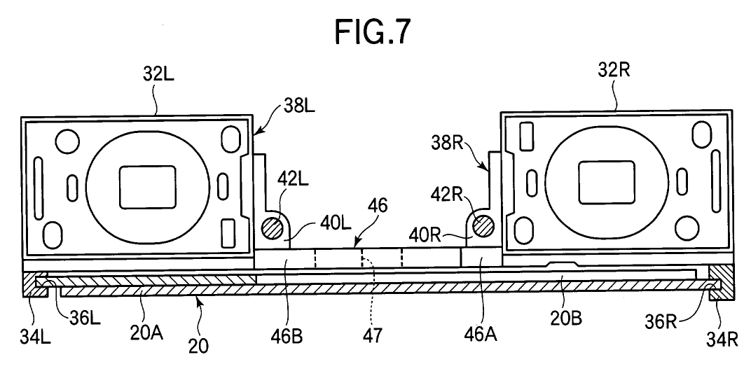

FIGS. 6 and 7 show a right mount plate 30R and a left mount plate 30L. The right mount plate 30R is provided for mounting the erecting prism system 14R of the right telescopic optical system 12R, and the left mount plate 30L is provided for mounting the erecting prism system 14L of the left telescopic optical system 12L. Upright plates 32R and 32L are provided along the rear peripheries of the right and left mount plates 30R and 30L. As shown in FIGS. 1 and 3, the right ocular lens system 15R is attached to the upright plate 32R, and the left ocular lens system 15L is attached to the upright plate 32L.

As shown in FIGS. 6 and 7, the right mount plate 30R is provided with a guide shoe 34R secured to the underside thereof in the vicinity of the right side edge thereof. The guide shoe 34R is formed with a groove 36R, which slidably receives a right side edge of the rectangular plate 20A, as shown in FIG. 7. Similarly, the left mount plate 30L is provided with a guide shoe 34L secured to the underside thereof in the vicinity of the left side edge thereof. The guide shoe 34L is formed with a groove 36L, which slidably receives a right side edge of the rectangular plate 20B, as shown in FIG. 7.

Note that since FIG. 7 is a sectional view along line VII-VII of FIG. 6, the optical system mount plate 20 should not be indicated in FIG. 7. Nevertheless, for the simplicity of the explanation, in FIG. 7, the optical system mount plate 20 is indicated as a section along line VII-VII of FIG. 5, and the guide shoes 34R and 34L are indicated as sectional views.

As shown in FIGS. 6 and 7, the right mount plate 30R has a side wall 38R provided along a left side edge thereof, and a lower portion of the side wall 38R is formed as a swollen portion 40R having a through bore for slidably receiving a guide rod 42R. The front end of the guide rod 42R is inserted in a hole 43R formed in the inside attaching portion 19R′ of the attaching base 19R, and is fixed thereto. The rear end of the guide rod 42R is inserted in a hole 45R formed in an upright fragment 44R integrally formed on a rear edge of the rectangular plate 20A, and is fixed thereto (see FIG. 5). Note that, in FIG. 5, the upright fragment 44R is indicated as a sectional view so that the hole 45R is observed, and in FIGS. 1 and 3, the rear end of the guide rod 42R is inserted in the hole 45R of the upright fragment 44R.

Similarly, the left mount plate 30L has a side wall 38L provided along a right side edge thereof, and a lower portion of the side wall 38L is formed as a swollen portion 40L having a through bore for slidably receiving a guide rod 42L. The front end of the guide rod 42L is inserted in a hole 43L formed in the inside attaching portion 19L′ of the attaching base 19L, and is fixed thereto. The rear end of the guide rod 42L is inserted in a hole 45L formed in an upright fragment 44L integrally formed on a rear edge of the rectangular plate 20B, and is fixed thereto. Note that, similarly to the upright fragment 44R, in FIG. 5, the upright fragment 44L is indicated as a sectional view so that the hole 45L is observed, and in FIGS. 1 and 3, the rear end of the guide rod 42L is inserted in the hole 45L of the upright fragment 44L.

The objective lens system 13R of the right telescopic optical system 12R is disposed at a stationary position in front of the right mount plate 30R. Therefore, when the right mount plate 30R is moved back and forth along the guide rod 42R, the distance between the objective lens system 13R and the erecting prism system 14R is adjusted, so that a focusing operation of the right telescopic optical system 12R is performed. Similarly, since the objective lens system 13L of the left telescopic optical system 12L is disposed at a stationary position in front of the left mount plate 30L, by moving the left mount plate 30L back and forth along the guide rod 42L, the distance between the objective lens system 13L and the erecting prism system 14L is adjusted, so that a focusing operation of the left telescopic optical system 12L is performed.

In order to simultaneously move the right and left mount plates 30R and 30L along the guide rods 42r and 42L such that a distance between the right and left mount plates 30R and 30L is variable, the mount plates 30R and 30L are interconnected to each other by an expandable coupler 46, as shown in FIGS. 6 and 7.

In particular, the expandable coupler 46 includes a rectangular lumber-like member 46A, and a forked member 46B in which the lumber-like member 46A is slidably received. The lumber-like member 46A is securely attached to the underside of the swollen portion 40R of the side wall 38R at the forward end thereof, and the forked member 46B is securely attached to the underside of the swollen portion 40L of the side wall 38L at the forward end thereof. Both members 46A and 46B have a length which is greater than the distance of movement of the movable casing section 10B, between its retracted position (FIGS. 1 and 2) and its maximum extended position (FIGS. 3 and 4). Namely, even though the movable casing section 10B is extended from the retracted position to the maximum extended position, slidable engagement is maintained between the members 46A and 46B.

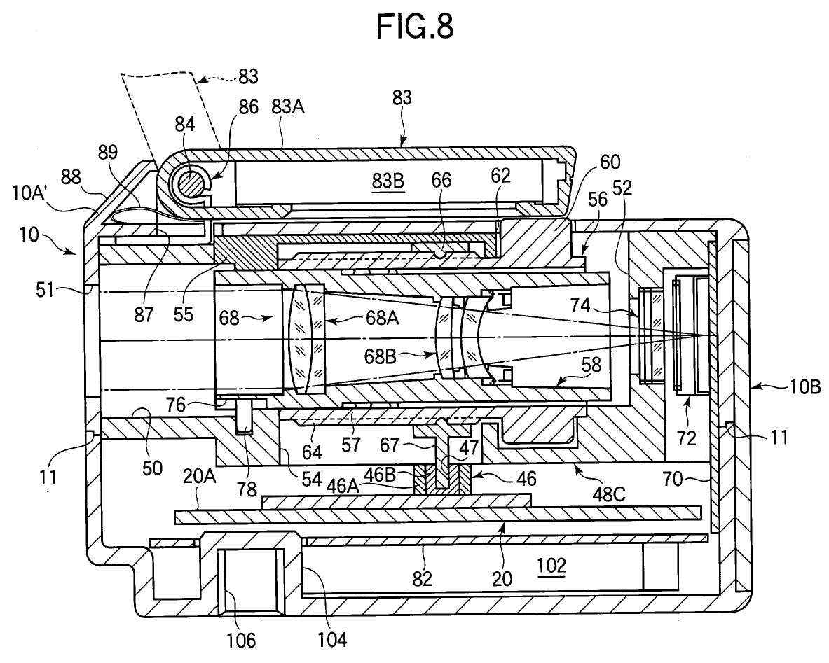

With reference to FIG. 8, there is shown a vertical sectional view along line VIII-VIII of FIG. 1. As understood from FIGS. 2, 4, and 8, an inner frame 48 is housed in the casing 10, and is fixed to the main casing section 10A and the rectangular plate 20A. The inner frame 48 has a central portion 48C, a right wing portion 48R extending from the central portion 48C rightward, a vertical wall 48S extending from a right periphery of the right wing portion 48R downward, and a left wing portion 48L extending from the central portion 48C leftward.

As shown in FIG. 8, a bore 50 is formed in a front end portion of the central portion 48C, and is aligned with a circular window 51 formed in a front wall of the main casing section 10A. A recess 52 is formed in a rear portion in the central portion 48C, and a rectangular opening 54 is formed in a bottom of the recess 52. A top wall of the main casing section 10A is provided with an opening for exposing the recess 52, and the opening is closed by a cover plate 55 which can be removed from the opening.

A tubular assembly 56 is assembled in the recess 52 while the cover plate 55 is removed. The tubular assembly 56 has a rotary wheel cylinder 57 and a lens barrel 58 disposed coaxially in the rotary wheel cylinder 57. The rotary wheel cylinder 57 is rotatably supported in the recess 52, and the lens barrel 58 can be moved along the central axis thereof while the lens barrel 58 is kept still so as not to rotate about the central axis. After assembling the tubular assembly 56, the cover plate 55 is fixed to cover the recess 52, and the main casing section 10A is then attached to the inner frame 48. A rotary wheel 60 is provided on the rotary wheel cylinder 57. The rotary wheel 60 has an annular projection formed on an outer surface of the rotary wheel cylinder 57, and the rotary wheel 60 exposes outside the top wall of the main casing section 10A through an opening 62 formed in the cover plate 55.

Helicoids 64 are formed on an outer surface of the rotary wheel cylinder 57, and an annular member 66 is threadingly fit on the helicoids 64. Namely, a plurality of projections, engaged with the helicoids 64 of the rotary wheel cylinder 57, are formed on an inner wall of the annular member 66, and disposed at a constant interval. A flat surface is formed on an outer periphery of the annular member 66, and is slidably engaged with an inner wall of the cover plate 55. Namely, when the rotary wheel cylinder 57 is rotated, the annular member 66 is not rotated due to the engagement of the flat surface and the inner wall of the cover plate 55, and is kept in a non-rotational state. Thus, when the rotary wheel cylinder 57 is rotated, the annular member 66 is moved along the central axis of the rotary wheel cylinder 57 due to the threading contact with the helicoids 64, and the moving direction depends on the rotational direction of the rotary wheel cylinder 57.

A tongue 67 is projected from the annular member 66, and is positioned at an opposite side of the flat surface of the annular member 66. As shown in FIG. 8, the tongue 67 is projected from the rectangular opening 54 of the central portion 48C, and is inserted in a hole 47 formed in the rod member 46A. Therefore, when a user rotates the rotary wheel cylinder 57 by contacting the exposed portion of the rotary wheel 60 with a finger, for example, the annular member 66 is moved along the central axis of the rotary wheel cylinder 57, as described above, so that the mount plates 30R and 30L are moved along the optical axes of the telescopic optical systems 12R and 12L. Thus, the rotational movement of the rotary wheel 60 is transformed into linear movements of the erecting prism systems 14R and 14L, and the ocular lens systems 15R and 15L, so that the telescopic optical systems 12R and 12L can be focused.

In this embodiment, the pair of telescopic optical systems 12R and 12L are designed, for example, in such a manner that, when the distance from each of the erecting prism systems 14R and 14L, and the ocular lens systems 15R and 15L to each of the objective lens systems 13R and 13L is the shortest, the pair of telescopic optical systems 12R and 12L focus on an object located at a distance between 40 meters ahead of the binocular telescope and infinity, and when observing an object between 2 meters and 40 meters ahead of the binocular telescope, the erecting prism systems and the ocular lens systems are separated from the objective lens systems so as to focus on the object. Namely, when the erecting prism systems are separated from the objective lens systems by the maximum distance, the pair of telescopic optical systems focus on an object located at a distance approximately 2 meters ahead of the binocular telescope.

A photographing optical system 68 is provided in the lens barrel 58, which is coaxially disposed in the rotary wheel cylinder 57. The photographing optical system 68 has a first lens group 68A and a second lens group 68B. A circuit board 70 is attached on an inner surface of a rear end wall of the main casing section 10A. A solid-state imaging device such as a CCD 72 is mounted on the circuit board 70, and a light-receiving surface of the CCD 72 is aligned with the photographing optical system 68. An opening is formed in a rear end portion of the central portion 48C of the inner frame 48, and is aligned with the optical axis of the photographing optical system 68. An optical low-pass filter 74 is fit in the opening. Thus, the binocular telescope of this embodiment has the same photographing function as a digital camera, so that an object image obtained by the photographing optical system 68 is formed on the light-receiving surface of the CCD 72 as an optical image.

In FIGS. 1 through 4, the optical axis of the photographing optical system 68 is indicated by the reference OS, and the optical axes of the right and left telescopic optical systems 12R and 12L are indicated by references OR and OL. The optical axes OR and OL are parallel to each other, and to the optical axis OS of the photographing optical system 68. As shown in FIGS. 2 and 4, the optical axes OR and OL define a plane P which is parallel to the optical axis OS of the photographing optical system 68. The right and left telescopic optical systems 12R and 12L can be moved parallel to the plane P, so that the distance between the optical axes OR and OL, i.e., the interpupillary distance, can be adjusted.

When the photographing optical system 68 is constructed to be able to perform pan-focus photography in which the photographing optical system 68 focuses an object including a near object, which is situated at a predetermined distance ahead of the binocular telescope, and an object at infinity, and a photographing operation is performed only in the pan-focus photography, a focusing mechanism does not need to be mounted in the lens barrel 58. However, when the binocular telescope is required to photograph a near object, which is situated less than 2 meters ahead of the binocular telescope similarly to a usual camera, the lens barrel 58 needs to be provided with a focusing mechanism.

Therefore, a female screw is formed on an inner wall of the rotary wheel cylinder 57, and a male screw, engaged with the female screw of the rotary wheel cylinder 57, is formed on an outer wall of the lens barrel 58. The front end of the lens barrel 58 is inserted in the bore 50, and a bottom portion of the front end is formed with a key groove 76, which extends from the front end of the lens barrel 58 in the longitudinal direction by a predetermined length. A hole is formed in a bottom portion of the front end of the inner frame 48, and a pin 78 is planted in the hole to engage with the key groove 76. Thus, by the engagement of the key groove 76 and the pin 78, the rotation of the lens barrel 58 is prevented.

Therefore, when the rotary wheel cylinder 57 is rotated by an operation of the rotary wheel 60, the lens barrel 58 is moved along the optical axis of the photographing optical system 68. Thus, the female screw formed on the inner wall of the rotary wheel cylinder 57 and the male screw formed on the outer wall of the lens barrel 58 form a movement-conversion mechanism that converts a rotational movement of the rotary wheel 57 into a linear movement or focusing movement of the lens barrel 58.

Helicoids 64 formed on the outer wall of the rotary wheel cylinder 57 and the female screw formed on the inner wall of the rotary wheel cylinder 57 are inclined in the opposite direction to each other so that, when the rotary wheel cylinder 57 is rotated in such a manner that the erecting prism systems 14R and 14L and the ocular lens systems 15R and 15L are separated from the objective lens systems 13R and 13L, the lens barrel 58 is moved to separate from the CCD 72. Due to this, an image of a near object can be focused on the light-receiving surface of the CCD 72. The pitch of the helicoids 64 and the pitch of the female screw of the inner wall are different from each other in accordance with the optical characteristics of the pair of telescopic optical systems 12R and 12L and the photographing optical system 68.

As shown in FIGS. 1 through 4, a power supply circuit board 80, which is relatively heavy, is provided in a right end portion of the main casing section 10A. As shown in FIGS. 2, 4, and 8, a control-circuit board 82 is provided between the bottom of the main casing section 10A and the optical system mount plate 20, and is fixed on the bottom. Electronic parts such as a CPU, a DSP, a memory, a capacitor, and so on are mounted on the control circuit board 82, and the circuit board 70 and the power supply circuit board 80 are connected to the control circuit board 82 through a flat flexible wiring cord (not shown).

As shown in FIGS. 2, 4, and 8, an image display panel or LCD monitor 83 is disposed on an upper surface of the top wall of the main casing section 10A, and is rotatably supported by the inner frame 48, so that the LCD monitor 83 is moved between a folded position, shown by a solid line in FIG. 8, and a display position, shown by a broken line in FIG. 8.

The LCD monitor 83 has a flat rectangular frame 83A and an LCD unit 83B housed in the rectangular frame 83A. The LCD unit 83B has a display surface, which exposes from a side of the rectangular frame 83A, and has an image indicating area for indicating an image. When the LCD monitor 83 is set to the folded position, the display surface of the LCD unit 83B faces an upper surface of the main casing section 10A, the display surface cannot be seen. Conversely, when the LCD monitor 83 is rotated and raised from the folded position to the display position, the display surface faces rearward, i.e., to a side of the ocular lens systems, so that the display surface can be seen by the user.

For the rotation of the LCD monitor 83, a rotational shaft 84 is provided on a front edge portion of the rectangular frame 83A, and both ends of the rotational shaft 84 are fixed or supported by the rectangular frame 83A. As shown in FIGS. 2 and 3, a pair of notches 85 is formed in the front edge of the rectangular frame 83A, where the rotational shaft 84 exposes. The rotational shaft 84 is rotatably supported by bearing members 86 provided in the notches 85. The bearing members 86 are fixed on a front portion of the inner frame 48.

Each of the bearing members 86 is obtained by bending a plate spring material by the right angle as shown in FIG. 8, one end of the bearing member 86 being a bearing enclosing the rotational shaft 84, and the other end of the bearing member 86 being attached to the front portion of the central portion 48C. The inner diameter of the bearing of the bearing member 86 is slightly smaller than the outer diameter of the rotational shaft 84, so that the rotational shaft 84 is elastically held by the bearing. Namely, a proper frictional force always exists between the bearing members 86 and the rotational shaft 84, and thus, when the LCD monitor 83 is positioned between the folded position and the display position, the LCD monitor 83 can be held at an arbitrary position between the folded position and the display position.

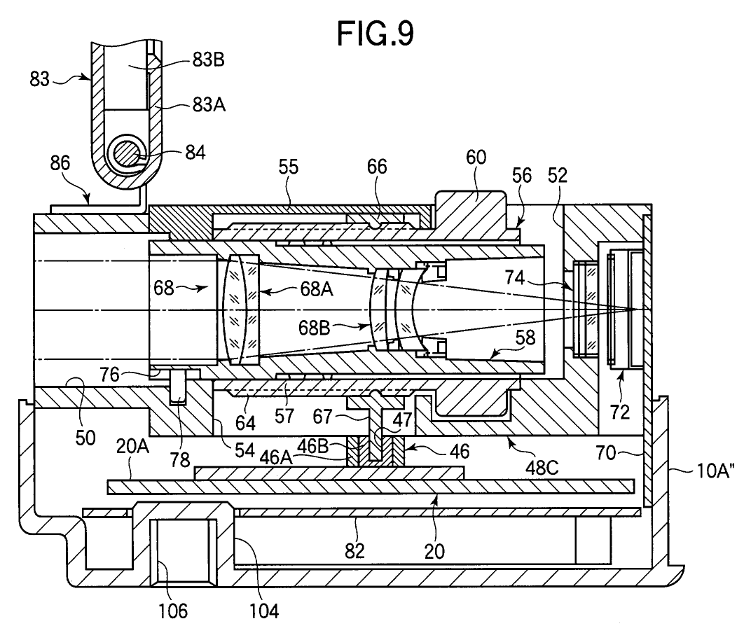

FIG. 9 is a sectional view similar to FIG. 8. However, in FIG. 9, the top part 10A′ of the main casing section 10A is removed and the LCD monitor 83 is positioned vertical to an upper surface of the front portion of the central portion 48C. Whenever the top part 10A′ of the main casing section 10A is attached to or removed from the inner frame 48, the LCD monitor 83 is positioned vertical to the upper surface of the front portion of the central portion 48C, so that the top part 10A′ can be attached to and detached from the inner frame 48 without interfering with the LCD monitor 83.

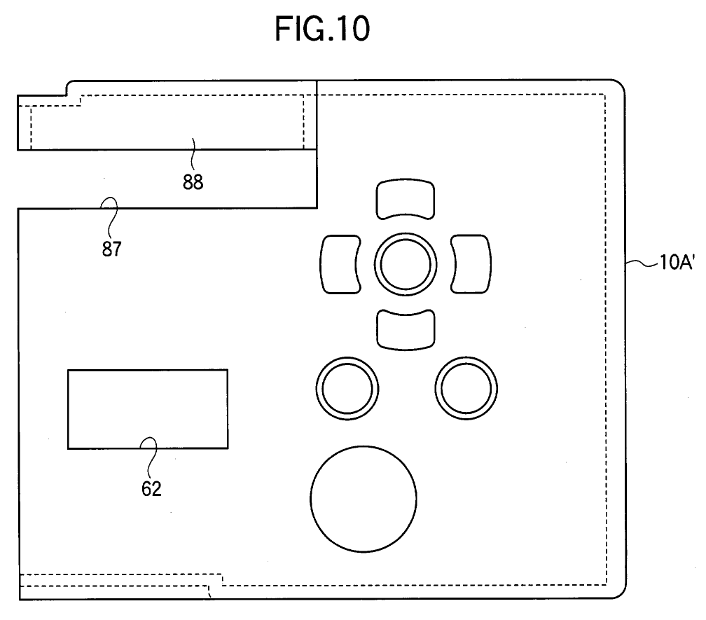

Namely, as shown in FIGS. 8 and 10, a panel passing opening 87 is formed in the top part 10A′ of the main casing section 10A, and has a size corresponding to a cross sectional shape of the LCD monitor 83. Therefore, by positioning the LCD monitor 83 at the upright position relative to the upper surface of the front portion of the central portion 48C as shown in FIG. 9, the LCD monitor 83 can pass through the panel passing opening 87 when the top part 10A′ is attached to or removed from the inner frame 48.

A slant plate 88, extending along a part of a periphery of the panel passing opening 87, is integrally formed in a front edge of the top part 10A′ of the main casing section 10A. The slant plate 88 is projected from a periphery of the panel passing opening 87 by the thickness of the LCD monitor 83 to cover a portion of the LCD monitor 83 around the rotational shaft 84. Namely, when the top part 10A′ is attached to the inner frame 48, the slant plate 88 covers the panel passing opening 87 in association with the LCD monitor 83, so that the panel passing opening 87 is prevented from exposing to the outer surface of the binocular telescope with a photographing function. The display surface of the LCD monitor 83 covers the panel passing opening 87, and a rear surface of the LCD monitor 83, opposite to the display surface, is positioned at substantially the same height as the slant plate 88, when the display panel is set to the folded position. Thus, the slant plate 88 functions as a cover covering the panel passing opening 87 which would otherwise lower the esthetic appearance of the binocular telescope.

The LCD unit 83B is connected to the power supply circuit board 80 and the control circuit board 82 through a flat flexible wiring cord. As described above, since the LCD monitor 83 is rotatable between the folded position and the display position, the flexible wiring cord should have an extra length so as to deform in compliance with the movement of the LCD monitor 83. In FIG. 8, the extra length is indicated by reference 89, which is housed in a space formed between the LCD monitor 83 and the cover or slant plate 88.

As shown in FIG. 10, the top part 10A′ of the main casing section 10A is formed with the panel passing opening 87 and the opening 62, through which the rotary wheel 60 exposes. Further, as understood from FIG. 10, the top part 10A′ is formed with other openings, through which switch buttons disposed on the right wing portion 48R of the inner frame 48 expose.

The left end portion of the movable casing section 10B is divided by the partition 29, to form a battery chamber 90 in which batteries 93 are housed. As shown in FIGS. 2 and 4, a lid 91 is provided in a bottom wall of the battery chamber 90. By opening the lid 91, the batteries 93 can be mounted in or removed from the battery chamber 90. The lid 91 forms a part of the movable casing section 10B, and is fixed at a closing position shown in FIGS. 2 and 4 through a proper engaging mechanism.

The weight of the power supply circuit board 80 is relatively high, and similarly, the weights of the batteries 93 are relatively high. In the embodiment, two components having a relatively large weight are disposed at both ends of the casing 10. Therefore, the weight balance of the binocular telescope with a photographing function is improved.

As shown in FIGS. 1 and 3, electrode plates 94 and 96 are provided at front and rear portions of the battery chamber 90. The batteries 93 are arranged in parallel to each other in the battery chamber 90, and directed in the opposite directions in the battery chamber to contact the electrode plates 94 and 96. The electrode plate 94 is electrically connected to the casing 10, and the electrode plate 96 is electrically connected to the power supply circuit board 80 through a power source cable (not shown) so that electric power is supplied from the batteries 93 to the power supply circuit board 80. The power supply circuit board 80 supplies electric power to the CCD 72 mounted on the circuit board 70, the electric parts such as the microcomputer and the memory mounted on the control circuit board 82, and the LCD monitor 83.

As shown in FIG. 1 through FIG. 4, it is possible to provide a video output terminal 98, for example, as an external connector, on the power supply circuit board 80, and in this case, a hole 100 is formed in the front wall of the main casing section 10A so that an external connector is connected to the video output terminal 98. Further, as shown in FIGS. 2 and 3, a CF-card driver 102, in which a CF-card can be detachably mounted as a memory card, may be provided below the control circuit board 82 on the bottom of the main casing section 10A.

As shown in FIGS. 2, 4, and 8, a screw hole forming part 104 is integrally formed on the bottom part 10A″ of the main casing section 10A. The screw hole forming part 104 is a thick portion having a circular section, and a screw hole 106, opening to an outer surface of the bottom part 10A″, is formed in the thick portion. The screw hole 106 of the screw hole forming part 104 is connected to a screw attached to a tripod head.

As described above, when the binocular telescope with a photographing function is examined to determine whether it operates properly or not, the casing 10 is removed from the binocular telescope, so that components including the power supply circuit board 80 and the control circuit board 82 can be accessed when needed. Further, since the LCD monitor 83 is mounted not on the casing 10, but on the inner frame 48, it is not necessary to provide a temporary space for placing the LCD monitor 83 when checking the binocular telescope.

Although, in the above embodiment, a binocular telescope with a photographing function is an example of the portable apparatus, the present invention can be applied to other portable apparatus such as a digital camera.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2002-122378 (filed on Apr. 24, 2002) which is expressly incorporated herein, by reference, in its entirety.

1. A portable apparatus comprising:
an inner frame;
a casing attached to said inner frame; and
a display panel that is directly connected to said inner frame and is movable between a folded position and a display position;
said casing being provided with a panel passing opening, through which said display panel, set at a predetermined position between said folded position and said display position, passes so that said casing is attached to and detached from said inner frame.

2. A portable apparatus according to claim 1, wherein said casing is provided with a cover that covers said panel passing opening in association with said display panel so that said panel passing opening is not exposed after said casing is attached to said inner frame.

3. A portable apparatus according to claim 2, wherein said cover is integrally formed on said casing.

4. A portable apparatus according to claim 3, wherein said display panel and said cover form a space therebetween, in which a part of a flexible wiring cord connected to said display panel is housed.

5. A portable apparatus according to claim 2, wherein said display panel is rotatably supported by said inner frame, said panel passing opening having a size corresponding to a cross sectional shape of said display panel, said cover being projected from a periphery of said panel passing opening by the thickness of said display panel to cover a portion of said display panel where said display panel is rotatably supported.

6. A portable apparatus according to claim 5, wherein said display panel has a display surface on which an image indicating area for indicating an image is provided, said display surface covering said panel passing opening, and a rear surface of said display panel, opposite to said display surface, being positioned at substantially the same height as said cover, when said display panel is set to said folded position.

7. A portable apparatus according to claim 1, further comprising an electronic photographing device having a photographing optical system and an imaging device operating in combination with said photographing optical system, said display panel indicating an image obtained by said electronic photographing device.

8. A portable apparatus according to claim 7, further comprising an observation optical system functioning as a viewfinder optical system for said electronic photographing device.

9. A portable apparatus according to claim 8, wherein said observation optical system comprises a pair of telescopic systems.

10. A portable apparatus according to claim 9, further comprising an optical system mount plate that is supported by said inner frame so as to support said pair of telescopic optical systems, said optical system mount plate having first and second plates that are slidable relative to each other, one of said pair of telescopic optical systems being mounted on said first plate, another of said pair of telescopic optical systems being mount on said second plate, a relative position between said first and second plates being changed so that a distance between the optical axes of said pair of telescopic optical systems is adjusted.

11. A portable apparatus according to claim 10, wherein said first and second plates are linearly moved relative to each other in such a manner that the optical axes of said pair of telescopic optical systems are moved in a predetermined plane, so that the distance between the optical axes of said pair of telescopic optical systems is adjusted.

12. A portable apparatus according to claim 11, wherein said casing comprises a main casing section that is fixed on said first plate, and a movable casing section that is fixed on said second plate and that is movable between a retracted position and an extended position relative to said main casing section, said panel passing opening being formed in said main casing section.

13. A portable apparatus according to claim 12, wherein said main casing section is divided into a top part and a bottom part, said display panel being mounted on said top part, said panel passing opening being formed in said top part.
